(19) United States
(12) Patent Application Publication
(10) Pub. No.: US 2005/0278416 A1
(43) Pub. Date: Dec. 15, 2005

(54) Marketplace system computer network

(76) Inventors: Alan Kay, St. Augustine, FL (US); Charles Pyne, Norfolk, MA (US)

Correspondence Address: OPPEDAHL AND LARSON LLP, P O BOX 5068, DILLON, CO, 80435-5068, US

(21) Appl. No.: 09/681,206

(22) Filed: Feb. 22, 2001

Related U.S. Application Data
(60) Provisional application No. 60/186,068, filed on Feb. 29, 2000.
(60) Provisional application No. 60/270,349, filed on Feb. 21, 2001.

(51) Int. Cl. G06F 15/16

(52) U.S. Cl. 709/203; 705/26

(57) ABSTRACT

The invention contemplates an apparatus for communication among users through a network of central computers and user workstations. An individual marketplace system consists of one or more central computers and a plurality of user workstations, wherein an individual marketplace involves a particular industry or other topic of interest. Users of the system are consumers, suppliers, and organizations or servicers who are linked to the network through their respective workstations. Each marketplace system is operated by a sponsor and their agents who determine whether the marketplace system is open or closed with regard to who may use their respective marketplace system. Message switching/distribution centers facilitate communications within an individual marketplace system, but users of one marketplace system may communicate with other marketplace systems. The communications of users comprise messages, transactions, etc. between users, with such communications consisting of data. Data, before being transmitted to other users, is verified by the central computer as being a legitimate transmission in order to ensure security and privacy.

### CROSS REFERENCE TO RELATED APPLICATION

This application claims priority from U.S. appl. No. 60/186,068 filed Feb. 29, 2000, and U.S. application No. ______, filed February __, 2001, attorney docket no. AKCPP002PV, which applications are hereby incorporated herein by reference.

### BACKGROUND OF INVENTION

This invention relates to a computer network, specifically a secure computer network wherein individual parties independently control and operate distinct sectors of the network for the benefit of consumers, sellers and other parties within their respective industries or areas of interest.

The Internet evolved from Arpanet, a network designed to allow main frame computers, built for the Department of Defense (DOD) in the era 1947-1969 and located in various facilities around the US, to be linked initially by AT&T telephone lines so that these almost one-of-a-kind DOD computers could work together to satisfy DOD's growing computing needs. The concept for Arpanet proposed by Bolt, Beraneck, and Newman (BB&N) and accepted by ARPA, the Advanced Research Project Agency of DOD, was based on BB&N developing a computer, the IMP (Interface Message Processor) of a new type: (1) able to send messages from one IMP to another, (2) programmable to communicate with a DOD computer, and (3) any authorized programmer at one facility on Arpanet was able to upload and download both programs and data from/to any other Arpanet computer. For example, four programmers working at four universities with different DOD computers would be able to work together to develop new systems software almost as readily as they could do in a single facility. When Arpanet started with a small number of facilities linked in this fashion, the key programmers knew each other and authorization was collegial and simple.

When Arpanet grew and was morphed into the Internet, the IMPs became ISPs (Internet Service Providers) that eventually were open to the general public. Depending only on small monthly payables, an ISP could link to the Internet anyone's personal computer. A person with access to that personal computer could then load programs and data onto any Internet user's hard drive (just as the Arpanet programmers used to do) unless the receiving computer had been programmed to prevent that intrusion. The ISP, having only a billing name and address and e-mail names of users, often could not be held accountable for the improper activity of its users.

Thus was born the virus and the war between (a) law-abiding users and (b) hackers, sociopaths and criminals. War, with its ever more complex and sophisticated offensive and defensive weapons, is an apt analogy. Few believe attacks by constantly mutating viruses will ever end as attackers and defenders continue to develop more clever and sophisticated means.

Thus was also born the opportunity for business marketeers. The word marketeers in this patent means those (whether ethical or unethical, legal or illegal) who put cookies on anyone's hard drive, collect information about Internet commercial activities and sell that information, particularly valuable to consumer-oriented businesses, which may often have inadequate regard for customer privacy and security.

Thus was also born the opportunity for large successful portals such as Yahoo and AOL to reconfigure user set-up and default settings without their knowledge, confusing many user s while benefitting themselves commercially.

For these reasons a Network System is desirable consisting of interlinked cooperative marketplace systems together providing and serving the desirable functions of the Internet, but do so better than the Internet in the sense described in the Summary and specified in the Claims.

### SUMMARY OF INVENTION

This patent describes features of a marketplace system of such nature that many such systems could be compatibly built for eventual linkage to each other. Each of ultimately thousands of these systems could be set up individually and owned by a variety of individuals, corporations, governments, or other organizations. Except for linkage features, these systems, would be expected in time to become a vast array of different designs, types and sizes, whatever their owners had chosen, and could be any design that meets the requirement of “marketplace systems” very broadly defined immediately following this Summary. Linkage of systems would be simple and not require merger or acquisition of a system owned by others. A network of all these systems, here called Betternet, could eventually emerge of such capacity and scope that it would accomplish what the Internet accomplishes with the following advantages over the Internet: (1) problems of viruses would be virtually eliminated, (2) there would be incentives for good software to emerge with far fewer bugs than now found in software linking a user's computer to the Internet, (3) each system would remain “open” (no application for user status need be rejected while the confidentiality of users' information is protected), (4) an end-to-end audit trail of all messages would make it possible to hold users accountable for any deliberate misinformation or bad data, and (5) privacy and security would automatically be protected much better than the Internet can do.

### BRIEF DESCRIPTION OF DRAWINGS

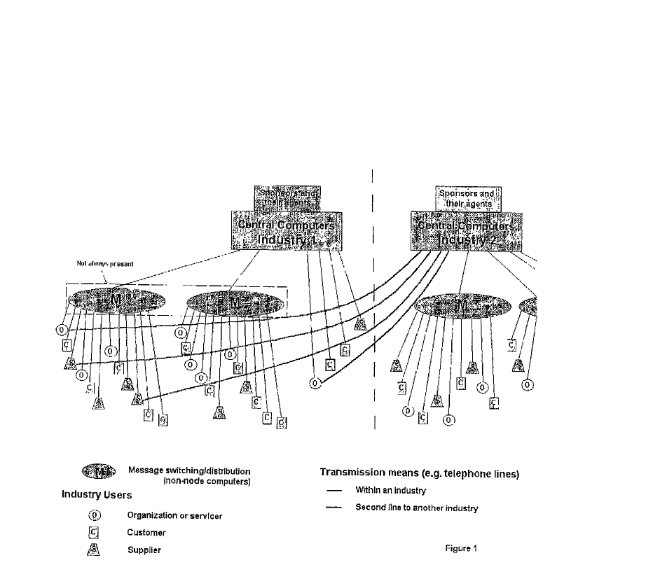

The accompanying drawing schematically illustrates the primary embodiment of the invention. FIG. 1 shows the relationships between central computers, message switching/distribution centers, users (i.e., suppliers, customers, and organizations or servicers), and transmission means.

### DETAILED DESCRIPTION

Marketplace Systems, Defining Terms. The marketplace system of FIG. 1 is a system that serves as the marketplace for one or more organizations in a generally competitive industry or sector that, by the use of output from suppliers and other industry-need-servicers, produces for customers products, services and/or data (or other marketable information) and generates orders to suppliers, which customers, organizations, and/or suppliers may in some cases participate in marketplace systems of other industries or sectors, producing an interlinked network of stand-alone marketplace systems.

A marketplace system, whether stand-alone or one of an interlinked network of systems, is controlled by a sponsor or sponsors (sometimes called an owner) and links marketplace system users (principally, organizations and their suppliers, and/or customers) with each other in a communication network for the purpose of executing or assisting in the advertising of needs and interests; sending, distributing, and confirming orders and specifications; and/or the consummation, notification, settlement, and distribution of transaction-related information/data between users. Users may also include servicers' organizations which service all or many producers in the industry or sector, such as providers of specialized trade newsletters, journals, magazines, professional/technical support, research, workshops, conferences, conventions, training, accreditation, insurance, and shipping, and may also include trade associations that set standards, codes of conduct, dispute resolution procedures, and generally have oversight of the industry/sector or portions of it, and government agencies, which may regulate it.

A marketplace system consists of one or more central computers linked to workstations located in user offices or premises via the communication network consisting of various transmission means, such as satellite, telephone, cable, radio, and fiber-optical, for the distribution of the information carried by the system to and from users, which information, when processed or stored in the central computers, is often called data and when carried on the network, called messages, and which distribution is sometimes augmented by other computers and other switching devices (controllers, multiplexers, servers, etc.) which are included in the network to increase the capacity of the system to accommodate more users, and/or to increase the speed and capacity of message distribution of the data, and which central computers and workstations are considered as nodes of the network.

Workstations are personal computers, other computers, telecom devices, and/or telephones and may include TV monitors, keyboards, printers, and other data storage, input, display, processing, and retrieval devices. Transactions are generally thought of as buying and selling but can include brokering (acting as agent), leasing and lease servicing, renting, borrowing, bartering, financing, lending, shipping, insuring, credit-checking and extending, appraising, grading, tracking and verifying, losing/finding and returning, receiving and accepting selected (or all) products, services and/or data of the industry, A central computer may acknowledge, confirm, and assist in settling such transactions and/or can process, store, retrieve, and distribute ancillary materials associated with transactions such as confirmations, invoices, bills, payments, and various analyses and summaries of data generated by transactions over various time periods, and for these purposes have excellent, up-to-the-moment and historical data on all users' activities, credit-worthiness, coordinates, etc. Analyses and summaries may be of interest either to a single user, many users, the media, and/or the general public.

Enlarging Terms. Other terms used have to be defined. The word industry (or the alternative sector) is used in this patent to refer to a large group of users who have a business or professional need for regular communications with each other. In such a group not every user needs such communication with every other one, but each user has a need to communicate with a flexible, potentially substantial subgroup (or subgroups) of users and, in some cases, the whole group.

In this patent, for simplicity, we use the language of business, for example, “marketplace” systems. A more generic term than “marketplace systems” is “network systems”. In this patent, Network Systems, is restricted to those network systems that comply with the requirements and receive the benefits stated in the Summary and specified in the Claims.

This patent, however, intends to cover not only industries but broader user groups. Such groups have somewhat less involvement with monetized transactions than industries do, but they do have some. These are groups of entities like non-profit organizations, professions, and communities. For example, government agencies, hospitals, schools, universities, foundations, health-care providers, and criminal justice system participants all fit into this category.

Such entities require communication means to perform many of the money-based transactions of marketplaces. Their other (non-monetary) activities can be thought of as non-monetary transactions. Examples of non-monetary transactions are asking for and getting (or offering and receiving) assistance, support or permission to (1) review, study, perform, or disseminate specific topics, programs, and features, e.g., seeking a patent (2) prepare or distribute certain data, stories, information, reports, and articles in specific ways.

With the meaning of transactions slightly broadened in this fashion, the patent covers improved communications within and among all such entities as well as within and among all industries.

Operation. This patent discloses a system that is a network of interlinked Network Systems which are compatible as specified in Element (C); protects users, as described in Elements (A) and (B); possesses strong incentives for System owners (who are willing to forego a user role in their System in order to do better financially in the long run) to eliminate viruses and greatly reduce bugs, as described in Elements (D) and (E); to protect the privacy and security of users, as described in Element (E); can determine an end-to-end audit trail of all messages to hold users accountable for any deliberate misinformation or bad data, as described in Element (F); and possessing convenient compatible password and identification protocols simplifying user access, as described in Element (G).

(A). Users are authorized by the sponsor(s) to participate on the system and have codes assigned by the sponsor(s) to uniquely identify the messages originated by them that are considered by form, check digits, message digest, and/or identifying code to be valid system messages. Users who wish to communicate with, send or receive data from the marketplace system sets an indicator on its workstation that flags their desire. Using circuit polling or similar methods, marketplace computer(s) actually trigger when the message in the out box of the user's workstations gets sent back to them or, as appropriate, when it returns the data requested by the user to its in box.

(B). Data is kept secure and protected by system software for the central computer(s) and/or for workstations, which software is designed to keep the program files on these computers isolated from all data files, by permitting no messages or any character or byte strings masquerading on the marketplace as system messages to be allowed into the working memory of said computers without verifying that said strings were originated by an authorized user and, where applicable, represent one of the valid message types that are permitted by the system software to be transmitted by that user, and which messages, when the sponsor deems it desirable or necessary, are confirmed as valid messages sent by an authorized user, by echoing the message back to the user's workstation, which verifies its receipt, such that if the message had been sent by an unauthorized agent or other person, it may generate a notice to the sponsor and/or be promptly deleted from the system and the damage it may have done can be immediately limited, redressed, and/or with due process punished.

(C). A marketplace system that is inherently compatible with other marketplace systems all designed to be compatible with each other as follows: (C)(i) Users of one compatible marketplace system, if they so choose, can use the same identifier, user name, and password in a second system for sending or receiving messages. When a user sends a message in a compatible marketplace, for example, the message header carries the same user identifier as it does when the user sends it to another compatible marketplace, except that the system computer(s) in each marketplace add their own system identifier numbers and their circuit polling, circuit and station numbers. The user need not be aware of these system identifier numbers. Similarly if a message sender designates a recipient on another compatible marketplace system, the sender does not need to know the compatible marketplace systems number, unless it wishes to send the message only to the recipient as a user on a specific system, in which case the sender must include that specific system number.

(C)(ii). When a message is a request to receive or send data that must be transferred from one compatible marketplace system to another, the message sender must be aware that the message header and text must conform to the allowed message types of both systems and the two systems when linked are prepared to send messages and data in this way with a convention that if one of the two systems does not allow a message type allowed by the other, the sender may have its request-to-send fail and receive notice of that failure with possible suggestions to use whatever compatible message types the two systems have that may be satisfactory for the purpose of the sender.

(D). If the interlinked marketplace of compatible marketplace systems has systems only described as type (A), (owned and operated by entrepreneurs whose only source of revenue from the growing network is as the owner of a marketplace system), then all parties operating the network have both the control means and the financial incentives to block viruses and to reduce bugs to an absolute minimum.

(E). (Opting-in only) Allowed message types will generally exclude market research techniques that are common on the Internet, where marketeers can plant cookies on a user's hard drive. Such messages will be permitted only when it has been verified by a network system that a user has confirmed that a specific marketeer has permission to send cookies to its hard drive, and such authorization has not yet been withdrawn.

(F). Users of any compatible linked network are held accountable for their entries. A complete audit trail for every message entered or received will be maintained in Betternet, unlike the Internet where ISP's are often unable to identify who actually sent/received a specific message.

(G). Protocols based on Boolean logic to accommodate designations of subsets of all users of Betternet that facilitate the needs of users about to send a message to easily and mnemonically select who of all those on Betternet will be permitted to receive that message or, alternatively, to receive sets of, or types of, messages, designating recipients, ultimately even when recipients or senders number in the hundreds of thousands. Similar protocols screen out the reception of unwanted messages or data.

Proliferation, Growth, and Linkage of Compatible Marketplace Systems. FIG. 1 illustrates schematically a first network system, labeled Industry 1, and a second network system, labeled Industry 2. Consider Industry 1 as a prototype. At the top of the Figure is the sponsor or sponsors of the system (and their agents) who directly control the central computers (or in the simplest case, a central computer) and who are responsible for the detailed design and operation of the system including the rules of system operation and the schedules of user participation charges.

The central computer(s) are linked directly to the organizations including, at the core of the industry, competitors, servicers, suppliers, and customers. In some cases the industry has more vertical structure than appears on this schematic, for example, when the industry product arises from mining, agriculture, or other natural resources and production proceeds sequentially from extraction to manufacturing to distribution. Distribution itself may have several levels such as marketing, wholesaling, retailing, and consumer purchase. Each of these levels may be linked to the central computer(s) where the suppliers of one level are the customers of another.

Some users may be linked to the central computer(s) through message switching and distribution computers, labeled M, whose purpose is to increase the capacity and speed of the system.

Messages may or may not be broken into packets, each short packet being treated as a message, as is done by Internet protocol. That distinction is not relevant to this patent. In any case, Network Systems require central computer(s) to control message distribution by some method. One such method, circuit polling, breaks the network into circuits, linking subgroups of users to collectively and statistically utilize the full bandwidth of the network reliably with minimum delays and at least cost. Users on each circuit are polled in turn by the central computer(s) in order to determine and accommodate the moment-to-moment need of each user for sending and receiving messages. Polling algorithms, selected by various Network Systems, are designed to give each user fair shared access and service in a satisfactory way at a reasonable cost Some of the users of Industry 1 are also users in a similar or different capacity in Industry 2. They participate as users of both marketplaces. If such interlinked marketplaces are Network Systems, they are required to use compatible log-on, identification, user-name and password systems.

An important distinction must be made between marketplace systems. There are two types: (A), the sponsor(s) play no other role in the system than owner and operator of the computerized marketplace and (B), the sponsor(s) do play such a role.

Type (A) owners are typically entrepreneurs who have no significant financial interests in the industry or sector serviced by their system other than the success of their system.

Most marketplace systems are type (B). Moreover, most frequently, the largest and most powerful companies or organizations in the industry or sector, which require marketplaces for efficiently buying and selling (or other transaction-oriented activities) are also themselves the system owners. Being a user itself is their core business and typically is much more important than the value of the system to them in their capacity as owners. In this case, type (B) owners structure the design and operating details of the system and the operating rules and user charge schedules for other users in such a way as to maximize their profits or to optimize other values, such as market share, return-on-investment, positive cash flow, or even non-financial values, whatever is important to them as participants and users of the system. For example, if General Motors, whose interest is selling motorized vehicles, started as an owner of a serious marketplace system, its primary interest would be as a user, selling cars, not as a system operator. Two or more large companies in an industry may join together to start an industry marketplace system or merge their industry systems in order to bring in more participants and, following Metcalfe's law, bring more value to each of them.

Two or more marketplace systems of type (B) may arise that are competitive with each other and unlikely to cooperate because all of the rules of each marketplace have been skewed to benefit the owner-as-user and hence the two or more owners are direct business competitors. One of the two may eventually be bought out or put out of business by the other. Its users transfer to the survivor's system.

In the case of type (A), as soon as there are enough users of one system who also need to use another specific system, it benefits the entrepreneurs who have started the two systems to link them together. Each gets the benefit of increased activity following a quadratic growth with size, but they need divide the costs only linearly. This is an outcome of Metcalfe's Law, but was well known from e-commerce marketplaces that operated before the birth of the Internet. For example if both marketplaces are of equal size and have comparable functionality and activity, each with N participants, then the value of the combined system compared to the original system is (2N)²/N² and has increased four-fold while the cost has increased 2N/N or doubled. This relationship, quadratic or better on value and linear on cost, is an intrinsic quality of networks. Thus if marketplaces were always type (A), the growth and linkage would occur naturally to the benefit of users of all systems, but for type (B) that would no longer be generally true, since type (B) owners are oriented to their core businesses and have selected the system operating rules and user pricing schedules to reflect that competitive posture.

When network systems are not business-based but have other organizational foci such as a government agency or a non-profit organization, the descriptive language must be changed from what has been used in this section, but the stated principles remain the same.

Advantages

Viruses. In Network Systems described in this patent, all messages from one user sending out data to others or requesting data from others, are under control of the central computer(s) and must first go as a message to the central computer (s). The entrepreneur-owner of a Network System naturally requires that no message received from a user(for any kind of processing, including returning data to the same or other users, or requesting data from other users) that does not have a header conforming to system standards and particularly is not one of a relatively few allowed message types meeting all legitimacy standards, then it is deleted, not stored or sent to any user. User data in transit or storage in the central computer(s) must be isolated from all the central computer programs. When a Network System is unlinked to other Network Systems it is certainly in the interests of the entrepreneur owner to use a system design that separates programs from data in this way. This approach, unlike the Internet whose key features relevant here are described in “Background”, means that viruses will be unheard of. This remains true if these network systems are linked to each other by compatible, bug-free software.

Well-Tested, Bug-Free Software. When personal computer manufacturers began the race for market share beginning about 1980, it became clear that the one gaining the largest share would have the most applications software written for its operating systems by a rapidly growing software industry and would have the greatest interoperability among customers and thus have customers who could little afford to switch brands once they had been hooked in this way by the dominant manufacturer. To achieve market share, it was less necessary to keep current customers happy than to attract more buyers from the much larger universe of those not having a personal computer at all. Microsoft won the race for personal computer dominance in the '90s and became one of the most valued companies in the world. In the process, the personal computer industry learned that users could live with most bugs and with poorly designed software, by such means as (a) requiring careful system back-up procedures, (b) frequent system restarts, (c) experimenting with substitute software packages, and (d) other time-consuming get-around-the-problem activities. Important for our purposes is to note that all this has been true for personal computer software that linked a personal computer to a marketplace.

In contrast, the entrepreneurial marketplace system owner, dependent on ongoing fees from users, loses revenue if bugs slow down or shut down the system in whole or in part. For the same reason, entrepreneurs (a) will generally arrange to have complete real-time computer backup and uninterrupted power supply capability, (b) will require much more careful debugging of all new hardware and software before either one goes into the operating system, (c) will require reversion to the tried-and-true version as soon as a bug appears in newly installed software, and (d) will have excellent support for those customers who have problems with the workstations that link them to the central computer(s). All this means that the Network Systems described in this patent will inherently be much less buggy than much of the software that computer users typically find individually or when on the Internet.

Privacy Rights. The rule for marketplace systems described in this patent is that, using the control capability of central computers already described, no user of a Network System, whether stand-alone or linked to other Network System, can place anything unsolicited or unrecognizable by the central computer(s) as an allowed message type on the hard drive of a user's personal computer without permission of the user. In the long run this would require that if a marketeer associated with one user wished to receive permission to put cookies on the hard drives of others, or to reconfigure user set-up and default settings without their knowledge, the first user would have to get permission from the others, one-by-one, and ideally not by messages on the system requesting permission, but by some alternate means of communication, such as postal mail, fax, FedEx, etc.

On the Internet in the year 2000, marketeers, such as DoubleClick, have promoted a concept that they should be allowed to place cookies on hard drives unless the recipient “opts out”, which means that the recipient must send a message that it does not wish to receive such cookies, which action itself often reveals information about the recipient that the marketeer might also find saleable. It is in the financial interest of the marketeer to make opting out not easy. If the user does opt out, the marketeer can, with one excuse or another, again place cookies on the user's hard drive on the theory that this gives the user another chance to rescind its “opt-out” (or to “

re-opt-in”) by using as bait new, different options or benefits. Successfully opting out is so difficult that studies show that a very small percentage actually succeed in extricating themselves from the marketeer's grip. Marketeers typically reach millions of Internet users and can soon capture almost all those targeted.

What this patent teaches is that marketplace system users should be allowed to be free of cookies on their hard drives unless they “opt in”, that is give specific permission to a marketeer without being bothered by frequent solicitations by the marketeer for the user to “opt in”, which is why it is recommended that marketeers cannot even once send a system message to users requesting that they “opt in”, but must use some alternate communication method that does not burden system users.

This characteristic of the system is potentially very important because in the not too distant future there may be as many as a billion individuals and organizations on the Internet who may wish to place cookies on hard drives if they could avail themselves of the essentially cost-free mass delivery through e-mail and web site outreach for this purpose. An Internet user, if this were his/her only recourse, might have to spend the rest of his/her life deflecting marketeering or otherwise avoiding such system intrusions, compared with a single decision, whether or not to opt-in, if the system is set up as here taught. There are software and hardware means to protect privacy and security on the Internet, similar in purpose to virus protection means. But marketeers have incentives to develop means to counter the protection. Victims then counter the counter-protection. The ongoing never-ending fight for privacy and security continues on the Internet.

Open and Closed Systems. Intranets are often thought of as “closed” systems, while the Internet is believed to be the only “open” system (see, for example, The Industry Standard, “Gated Communities”, Nov. 27-Dec. 4, 2000, p. 178). Used in this sense, the explanation for an Intranet being called “closed” is that not anyone is allowed to use it, while the Internet is called open” because anyone is allowed to use it and millions do. Using these definitions marketplace systems as the term is used in this patent are not necessarily “closed”. When users send any message or data on a Network System they specify which of the users are sent that message or delivered that data.

This specification can be made by compact notation and Boolean logic covering all users and subsets of all, including subsets that are of value to the users. For example, recipients may be designated in a message header by user and list numbers, some preceded by a minus sign, signifying “excluded, even if otherwise included”. A list is a set of subscriber numbers and/or group numbers. Both a list and a group may be created by the Network System owner or by any user. Neither owner nor user can modify the lists or groups created by others. With these or similar precautions, a Network System owner can allow any user to readily designate recipients or screen out senders. If no users want the new participant to see their data, the new user will receive none. Those current users who choose not to receive some or all of the data of one user may screen out such data if the Network System owner provides that capability. Therefore a Network System may choose to allow anyone to become a user who is willing to take the small risk of seeing little of value. Network System owners of type (A) can generally be expected to keep their Systems open, but type (B)s will generally wish to keep them closed. None need keep its System closed. As their networks grow larger, type (A)s have more incentives to keep them open. Those of their users who are fussy about who sees their data retain complete control over who are recipients, will have no concern with this technicality, and will be satisfied with the outcome that type (A) owners run open Systems.

1. A marketplace system operated by a sponsor, the system interconnecting users having respective workstations and transmitting messages among the users, the system comprising means responsive to first inputs from the sponsor for authorizing participation by particular users; the system comprising means responsive to second inputs from users indicative of their wish to communicate, send, or receive data from the marketplace system; the system responsive to a second input from a first user indicative of a wish to send first data by validating said first data, and in the event the first data are validated, receiving the first data; the system responsive to receipt of the first data by returning second data to an inbox or output device on the workstation of the first user.

2. A network of networks comprising workstations associated with users, the network comprising communicative means communicating messages among the users, each message containing information indicative of a putative sender, each workstation comprising working memory and further comprising means keeping program files on the workstation isolated from data files on the workstation, the means blocking a received message from being allowed into the working memory thereof except after verification that the message was originated by an authorized user and is of a predetermined valid message type; the network further comprising means echoing the received message back to its putative sender, the means further responsive to a repudiation notice from the putative sender for deleting the message.

3. A marketplace network of networks interconnecting marketplace systems for passage of messages each message having a sender and a recipient, each marketplace system having associated users and having a respective arrangement of user identifiers, user names, and passwords, each marketplace system having an associated system identifier; the marketplace systems characterized in that a user may use the same identifier, user name, and password in more than one marketplace system; each message comprising information indicative of the system identifier of the system within which the message originates; the network further characterized in that the sender of a message includes a specific system identifier, whereby the network sends the message to the recipient as a user on the system associated with the specific system identifier.

4. A marketplace network of networks interconnecting marketplace systems for passage of messages each message having a message type, a sender and a recipient, each marketplace system having associated users and having a respective arrangement of user identifiers, user names, and passwords, each marketplace system having an associated system identifier; the marketplace systems characterized in that a user may use the same identifier, user name, and password in more than one marketplace system; the network comprising means transferring messages from a first marketplace system to a second marketplace system, the network further comprising means responsive to the event of a message's message type not being allowed by the second marketplace system for communicating a notice of failure of delivery, the notice comprising information indicative of message types compatible with the marketplace system of the sender and with the marketplace system of the recipient.

5. A network of networks system interconnecting marketeers and users, each user having a hard drive, the system comprising means receiving permissions and withdrawals of permission from particular users with respect to particular marketeers, the system further comprising means permitting transmission of a cookie from a marketeer to a user's data storage/retrieval memory only if the marketeer has permission to do so and only if such permission has not yet been withdrawn.

6. A network of networks interconnecting users entering and receiving messages, the network comprising means maintaining a complete audit trail for every message entered or received.

7. A network of networks interconnecting users sending and receiving messages, the network defining designations of subsets of all users indicative of needs of the users in the subsets, the network comprising means responsive to a first user sending a message and responsive to selection by the first user of one or more subsets, for distributing the message to users in the selected subsets, the network further comprising means responsive to a second user indicating unwantedness of certain messages for screening out the reception of the message.

8. A marketplace network of networks interconnecting marketplace systems for passage of messages each message having a message type, a sender and a recipient, each marketplace system having associated users and having a respective arrangement of user identifiers, user names, and passwords, each marketplace system having an associated system identifier; the marketplace systems characterized in that a user may use the same identifier, user name, and password in more than one marketplace system; each message comprising information indicative of the system identifier of the system within which the message originates; the network characterized in that the sender of a message includes a specific system identifier, whereby the network sends the message to the recipient as a user on the system associated with the specific system identifier; the network comprising means transferring messages from a first marketplace system to a second marketplace system, the network further comprising means responsive to the event of a message's message type not being allowed by the second marketplace system for communicating a notice of failure of delivery, the notice comprising information indicative of message types compatible with the marketplace system of the sender and with the marketplace system of the recipient.

9. A network of networks system interconnecting marketeers and users, each user having a hard drive being interconnected with other users and each user entering and receiving messages, the system comprising means receiving permissions and withdrawals of permission from particular users with respect to particular marketeers, the system comprising means permitting transmission of a cookie from a marketeer to a user's data storage/retrieval memory only if the marketeer has permission to do so and only if such permission has not yet been withdrawn, the system comprising means maintaining a complete audit trail for every message entered or received by users, the network of networks system further interconnecting users with other users sending and receiving messages, the system defining designations of subsets of all users indicative of needs of the users in the subsets, the system comprising means responsive to a first user sending a message and responsive to selection by the first user of one or more subsets, for distributing the message to users in the selected subsets, the system further comprising means responsive to a second user indicating unwantedness of certain messages for screening out the reception of the message.

10. The marketplace network of networks of claim 8 wherein the marketplace systems are operated by a sponsor, the systems interconnect users having respective workstations and transmit messages among the users, the systems comprising means responsive to first inputs from the sponsor for authorizing participation by particular users; the systems comprising means responsive to second inputs from users indicative of their wish to communicate, send, or receive data from the marketplace system; the systems responsive to a second input from a first user indicative of a wish to send first data by validating said first data, and in the event the first data are validated, receiving the first data; the systems responsive to receipt of the first data by returning second data to an inbox or output device on the workstation of the first user.

11. The network of networks system of claim 5 wherein the network of networks system comprises workstations associated with users, the network of networks system comprising communicative means communicating messages among the users, each message containing information indicative of a putative sender, each workstation comprising working memory and further comprising means keeping program files on the workstation isolated from data files on the workstation, the means blocking a received message from being allowed into the working memory thereof except after verification that the message was originated by an authorized user and is of a predetermined valid message type; the network of networks system further comprising means echoing the received message back to its putative sender, the means further responsive to a repudiation notice from the putative sender for deleting the message.
